(19) United States
(12) Patent Application Publication
(10) Pub. No.: US 2026/0213608 A1
(43) Pub. Date: Jul. 23, 2026

(54) DRIVE UNIT WITH ELECTRIC MOTOR POWERED BY BATTERY PACKS FROM DIFFERENT MANUFACTURERS

(71) Applicant: Lutz Pumpen GmbH, Wertheim (DE)

(72) Inventors: Karl-Heinz LUTZ, Kreuzwertheim (DE); Takumi NASU, Wertheim (DE)

(73) Assignee: Lutz Pumpen GmbH, Wertheim (DE)

(21) Appl. No.: 19/449,757

(22) Filed: Jan. 15, 2026

(30) Foreign Application Priority Data
Jan. 17, 2025 (DE) 10 2025 101 733.6

(51) Int. Cl. H02K 5/22

(52) U.S. Cl. CPC H02K 5/225

(57) ABSTRACT

Different manufacturers of battery-powered tools each provide their own battery packs, which differ in their shape and also in their terminals. In particular, in known battery packs, the DC voltage connections are sometimes reversed, whereas the voltage provided is the same. A drive unit is provided with an interchangeable adapter unit that is suitable for different battery packs from different manufacturers. This is achieved by a rotatable intermediate element that ensures that the polarity of the battery pack can always be correctly transmitted to the electric motor, despite its identical orientation with respect to the drive.

### CROSS REFERENCE TO RELATED APPLICATIONS

Applicant claims priority under 35 U.S.C. § 119 of German Application No. 10 2025 101 733.6 filed Jan. 17, 2025, the disclosure of which is incorporated by reference.

### BACKGROUND OF THE INVENTION

### 1. Field of the Invention

The present invention relates to a drive unit having a drive housing in which an electric motor, in particular for operating a container pump, is accommodated, wherein the drive housing is associated with an adapter unit for the detachable accommodation of a battery pack, the adapter unit having electrically conductive contact elements for contacting mating contact elements of the battery pack, and the contact elements being electrically connected to supply terminals of an electric motor accommodated in the drive housing.

### 2. Description of the Related Art

It is known to equip drive units for the operation of container pumps with electric motors, which are then supplied with the required electrical power via a power cable. However, it has also long been common practice to equip such electric motors with battery packs, allowing cordless operation. This eliminates the need for the electric motors to have a bothersome cable that the user can trip over and that may be a hindrance. More importantly, the operating location no longer needs to be in the vicinity of a power outlet, with the result that containers can be emptied in any location by means of battery-operated pumps.

In this context, it has become common for many power tools to be operated with easily replaceable battery packs, which are inserted and latched into a suitable adapter unit and brought into electrical contact there, said contact connecting the necessary contacts of the battery pack to the electric motor, at least including the two poles of the DC voltage. Due to the widespread practice of providing such battery packs for power tools, these are now available from numerous manufacturers and provide comparable voltages; however, manufacturers tend to encourage their customers to buy only power tools of their own brand. This is achieved in that the manufacturer's own battery packs have external shapes and terminals that do not cooperate with the adapter units of other manufacturers, either because the latching mechanisms are not compatible in their shape, because the size and shape of the battery packs differ, or because the terminals are reversed, such that the positive terminal is sometimes on the left and sometimes on the right.

In this context, the following documents are known from the prior art: DE 11 2013 006 567 T5, DE 41 00 453 A1 and DE 10 2021 104 825 A1.

### SUMMARY OF THE INVENTION

Against this background, the problem addressed by the present invention is that of creating a drive unit which has an electric motor and which can be operated using battery packs from different manufacturers by simply replacing an adapter unit.

The problem is solved by a device having the features disclosed herein. Practical embodiments of such a drive unit are also disclosed.

In this respect, a drive unit is provided having a drive housing in which an electric motor, in particular for operating a container pump, is accommodated, wherein the drive housing is associated with an adapter unit for the detachable accommodation of a battery pack, the adapter unit having electrically conductive contact elements for contacting mating contact elements of the battery pack, and the contact elements being electrically connected to supply terminals of an electric motor accommodated in the drive housing. According to the invention, this drive unit is characterized in that the adapter unit is detachably connected to the drive housing with the interposition of an intermediate element, and has contact pins electrically connected to the contact elements for contacting contact surfaces of the intermediate element that are insulated from each other and connected, via wire leads, to the supply terminals of the electric motor, wherein the intermediate element can be received between the adapter unit and the drive housing in a first position and in a second position rotated by 180° such that, upon a change from the first position to the second position, the assignment of the contact pins to the contact surfaces is changed.

In this context, it should be noted that the adapter unit can be selected to match any battery pack manufacturer. In other words, for a first manufacturer, a first adapter unit configured for their battery packs can be used; however, if the drive unit is to be set up for the battery packs of another manufacturer, the adapter unit is replaced, so that the battery packs of the other manufacturer can be connected to the electric motor via this adapter unit. Selecting the appropriate adapter unit ensures that the latching mechanism and the overall shape are compatible with the desired battery pack. However, this does not necessarily guarantee that the polarity is specified correctly.

For this purpose, the invention provides that the intermediate element is brought into electrically conductive contact with the adapter unit, such that the contact elements of the adapter unit press via contact pins onto contact surfaces of the intermediate element and thus establish electrical contact. The intermediate element may, in particular, be planar or disc-shaped and provides that its contact surfaces are connected to the supply terminals of the electric motor. The contact surfaces of the intermediate element may, for example, be labeled with the polarization, so that it is only necessary to rotate the intermediate element such that the polarities of the intermediate element match the corresponding labelling of the adapter unit. This way, an incorrect connection between the battery pack and the electric motor can be avoided even when different battery packs from different manufacturers are used.

In a first embodiment, it may be provided that the contact surfaces of the intermediate element are formed as sheet metal inserts which are placed on the intermediate element and form terminal, angled plug-in elements which are guided through openings of the intermediate element and are connected to the wire leads beyond the openings. In this way, simple electrical contacting between the contact pins of the adapter unit and these contact surfaces is made possible. The intermediate element closes off the interior of the drive housing at the top and provides an interface for the adapter unit. Since only insertion of the bent sheet metal inserts into an otherwise prefabricated plastic part is required, manufacture of the intermediate element in this way is inexpensive and simple to carry out. The plug-in elements on the side facing the electric motor can be readily connected with connecting wires, in particular when conventional forms of cable connections are used.

In a further embodiment, it may be provided that the contact surfaces are received in recesses of the intermediate element, such that the surfaces of the contact surfaces and the intermediate element merge flush with one another. In particular when the contact pins slide over the intermediate plate as the adapter unit is placed on top of the drive housing, this arrangement prevents the contact pins from snagging on the edges of the contact surfaces.

Preferably, it may further be provided that the adapter unit or intermediate element has raised elements and the counterpart has recesses, wherein electrical contacting between the contact pins and contact surfaces only takes place in a position in which the raised elements engage in the recesses, and the raised elements and the recesses are positioned such that a polarity of the battery pack specified by the adapter unit is correctly transmitted from the intermediate element to the supply terminals of the electric motor. As the adapter unit approaches the intermediate element, the raised elements will come into abutment with the surface of the counterpart; that is, if the raised elements are arranged on the intermediate element, they will abut the surface of the adapter unit, and if they are arranged on the adapter unit, they will abut the surface of the intermediate element. A functional connection between the adapter unit and the intermediate element is only achieved when the raised elements and the recesses, which may be formed as cavities, perforations, notches, and the like, interact with each other. The raised elements are arranged such that the polarity of the battery pack interacting with the selected adapter unit only corresponds to the polarity specified by the supply terminals of the electric motor if the intermediate element is inserted into its receptacle in the correct first or second position. The intermediate element must therefore be arranged in the first or second position, depending on the selected adapter unit, in order for mechanical assembly of the adapter unit with the drive housing to be possible.

However, the use of raised elements and recesses is not the only option. Alternatively, and with certain advantages, it may also be provided that the adapter unit has first raised elements and the intermediate element has second raised elements, wherein the first raised elements interact with corresponding second raised elements, wherein electrical contacting between contact pins and contact surfaces only takes place in a position in which the first raised elements are arranged next to the second raised elements, and the first raised elements and the second raised elements are positioned such that a polarity of the battery pack specified by the adapter unit is correctly transmitted from the intermediate element to the supply terminals of the electric motor. In this case, if the position of the intermediate element is incorrectly selected, raised elements will abut each other, so assembly is likewise not possible if the position of the intermediate element is not correctly assigned to the selected adapter unit.

Preferably, it may be provided that the drive housing has a tubular connection portion for connection to the adapter unit, the tubular connection portion interacting with the adapter unit via a screw thread. In such a case, it is ensured that the adapter unit is positioned directly above the drive housing and approaches it parallel to the surface when tightened.

With regard to mounting of the intermediate element, essentially two possibilities are provided for how the intermediate element behaves. Initially, it may be provided that the drive housing has a receptacle for the intermediate element, wherein the intermediate element is non-rotatably mounted in the receptacle. In the case of non-rotatable mounting, its position, i.e., first or second position, must be selected in advance. The intermediate element may have features in its shape, such as flattened portions or indentations, which engage in corresponding counter-shapes of the receptacle and prevent rotation of the intermediate element.

Alternatively, it may be provided that the drive housing has a circular receptacle for the intermediate element and that the intermediate element is mounted so as to be freely rotatable in the receptacle. In this case, it is advantageous if the adapter unit, during rotation, for example, during tightening, entrains the intermediate element and thus determines its position in such a way that an assembly error likewise cannot occur here, since the raised elements provided for entrainment cooperate such that entrainment can take place only to an extent at which the polarity corresponds to the battery pack used.

Specifically, it may be provided that the adapter unit has first raised elements and the intermediate element has second raised elements, with the first raised elements interacting with the second raised elements via lateral flanks. The flanks interact by twisting against each other, and the rotating part entrains the stationary part as soon as the flanks meet. Here, the position of the flanks and the raised elements is selected such that, at the moment the flanks come into contact with each other, the contact pins lie on the contact surfaces with the correct polarity.

To enable the adapter unit to be fixed to the drive housing, it may be provided that the drive housing has screw receptacles that correspond to screw passages of the intermediate element and of the adapter unit in an operating position of the adapter unit. Since the screws are ultimately screwed at least partially through the adapter unit and the intermediate element into the drive housing, they are mutually fixed in the achieved position, such that this position can no longer be changed without loosening the screw connection.

Finally, it may be provided that the contact pins of the adapter unit are resiliently mounted against the contact surfaces of the intermediate element by means of compression springs. Even in the presence of slight inaccuracies, this ensures that the contact pins are pressed firmly against the contact surfaces, so that reliable electrical contacting is always provided for proper operation of the drive.

### BRIEF DESCRIPTION OF THE DRAWINGS

The above-described invention is explained in more detail below with reference to an exemplary embodiment.

### In the Figures:

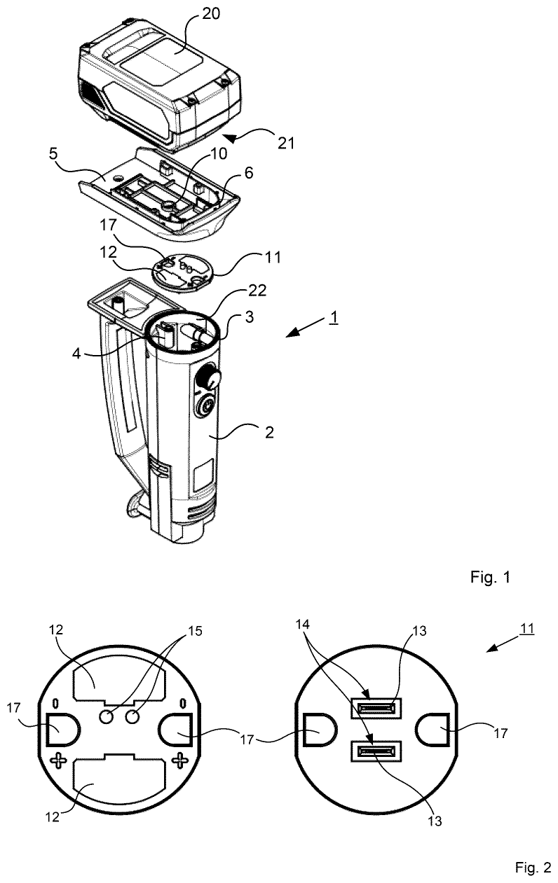

FIG. 1 shows a drive unit with an adapter unit and an intermediate element, as well as a battery pack, in a perspective exploded view,

FIG. 2 shows the intermediate element in two views in plan view, from above and from below,

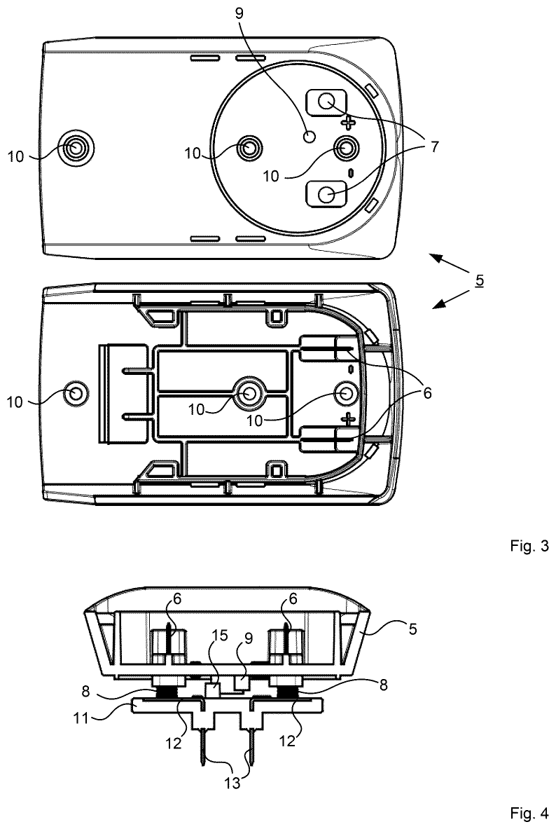

FIG. 3 shows the adapter unit in two views in plan view, from above and from below,

FIG. 4 shows the adapter unit mounted on the intermediate element in a frontal cross-sectional view, and

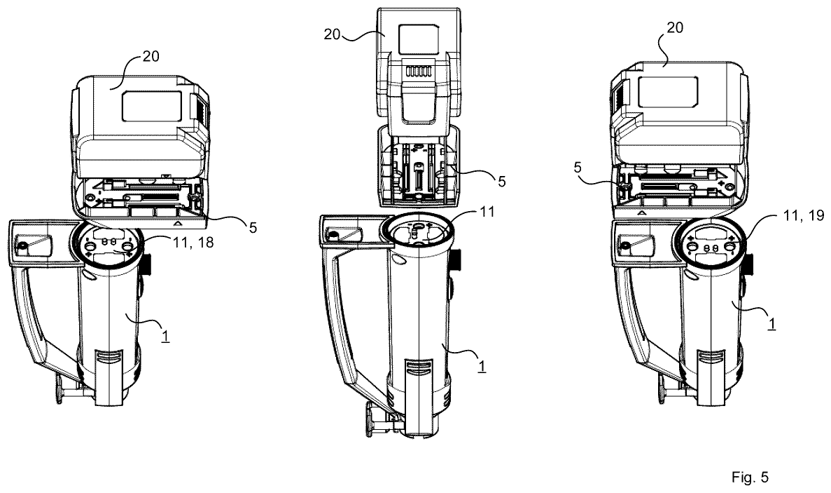

FIG. 5 shows the drive unit with an adapter unit and an intermediate element, as well as a battery pack in perspective exploded views in different positions of the intermediate element.

### DETAILED DESCRIPTION OF PREFERRED EMBODIMENTS

FIG. 1 shows an exploded view of a drive unit 1, illustrating various components and their arrangement. The drive unit 1 comprises a drive housing 2, an adapter unit 5, an intermediate element 11 and can be equipped with a battery pack 20, which is also illustrated.

The drive housing 2 is equipped with a tubular connection portion 3, which serves for connection to the adapter unit 5. The tubular connection portion 3 has a screw thread that interacts with the adapter unit 5 to ensure a secure mechanical connection. The drive housing 2 further contains screw receptacles 4, which correspond to screw passages 10 of the adapter unit 5 and screw passages 17 of the intermediate element 11, in order to enable stable fastening in the operating position.

The adapter unit 5 is intended for the detachable accommodation of the battery pack 20 and contains electrically conductive contact elements 6, which serve for contacting mating contact elements 21 of the battery pack 20. For such contacting, the battery pack 20 is usually inserted into the adapter unit 5 via an open end face of the adapter unit 5, shown here at the rear of the figure, and latched therein. In the latched position, the mating contact elements 21, which are not visible here and which may, for example, be pairs of spring elements pressing against each other, engage with the contact elements, which then push the spring elements apart and thereby establish electrical contact. The contact elements 6 are connected to contact pins 7 on the underside of the adapter unit 5, which are used for electrically contacting the contact surfaces 12 of the intermediate element 11. The contact pins 7 are resiliently mounted by means of compression springs 8 to ensure a reliable electrical connection.

The intermediate element 11 is arranged between the adapter unit 5 and the drive housing 2 and can be received in a receptacle 22 in a first position and a second position rotated by 180°. The intermediate element 11 has contact surfaces 12 which are formed as sheet metal inserts and form terminal, angled plug-in elements 13, which can be seen in FIGS. 2 and 4. These plug-in elements 13 are guided through openings 14 of the intermediate element 11 and, beyond the openings 14, are connected to wire leads that lead to the supply terminals of the electric motor. The contact surfaces 12 are received in recesses of the intermediate element 11, such that the surfaces of contact surfaces 12 and intermediate element 11 merge flush with one another.

The intermediate element 11 is non-rotatably mounted in the receptacle 22 in the connection portion 3 of the drive housing 2, which ensures stable positioning and a reliable electrical connection. If a different adapter unit 5 is used that is set up for a different battery pack 20, it may be necessary to reverse the polarity with respect to the electric motor. For this purpose, the intermediate element in the receptacle 22 can be rotated and inserted the other way around, while the wiring with the supply terminals of the electric motor is retained. This allows different battery packs from different manufacturers to be used with the same drive unit by simply attaching a different adapter unit 5 to the drive housing 2.

FIG. 2 shows a detailed view of the intermediate element 11 used in the drive unit 1 according to FIG. 1. The intermediate element 11 is shown in two views, with the left view showing an upper side facing the adapter unit 5 and the right view showing a rear side of the intermediate element 11 facing the electric motor. In the upper plan view, the contact surfaces 12, which are designed as sheet metal inserts, are clearly visible. These contact surfaces 12 are placed on the intermediate element 11 and terminate in angled plug-in elements 13, which are guided through openings 14 of the intermediate element 11. The contact surfaces 12 are received in recesses of the intermediate element 11, such that the surfaces of the contact surfaces 12 and the intermediate element 11 merge flush with one another. This ensures consistent and reliable contacting with the contact pins 7 of the adapter unit 5, even in the event of rotation. The second raised elements 15 are explained in more detail in the description of FIGS. 4 and 5. They serve to ensure correct positioning of the intermediate element 11 between the adapter unit 5 and the drive housing 2.

The lower view of the intermediate element 11 shows the angled plug-in elements 13, which are guided through the openings 14. These plug-in elements 13 are connected beyond the openings 14 to wire leads, which establish the electrical connection to the supply terminals of the electric motor.

The screw passages 17 are visible in both the front and rear views of the intermediate element 11. These passages 17 correspond to the screw receptacles 4 of the drive housing 2 and enable firm and secure fastening of the intermediate element 11 in the receptacle 22 of the drive housing 2. Correct positioning and fastening of the intermediate element 11 are essential for reliable electrical connection and the safe operation of the drive unit.

FIG. 3 shows the adapter unit 5 according to FIG. 1, which is provided for the detachable accommodation of a battery pack 20, in a view first from below, facing the intermediate element, and then in a view from above, facing the battery pack 20. The adapter unit 5 is equipped with electrically conductive contact elements 6, which serve for contacting mating contact elements of the battery pack 20. On the opposite side they are connected to contact pins 7, which ultimately establish electrical contacting, via the intermediate element 11, with supply terminals of an electric motor accommodated in the drive housing 2. The adapter unit 5 has a plurality of screw passages 10 which can be used for fastening to a drive housing or to an intermediate element.

FIG. 4 illustrates the adapter unit 5 and the intermediate element arranged beneath it in a side view, which shows the arrangement of the contact elements 6 and their connection to the contact pins 7. The contact pins 7 are resiliently mounted against the contact surfaces 12 of the intermediate element 11, with compression springs 8 being used to provide resilience of the contact pins 7. The contact surfaces 12 of the intermediate element 11 are formed as sheet metal inserts, which are placed in recesses on the intermediate element 11. These sheet metal inserts form terminal, angled plug-in elements 13, which are guided through openings 14 of the intermediate element 11 and are connected to wire leads beyond the openings 14.

The adapter unit 5 is equipped with first raised elements 9, which interact with corresponding second raised elements 15 of the intermediate element 11. These raised elements 9 and 15 are positioned such that contacting between the contact pins 7 and the contact surfaces 12 only occurs in a specific position. This ensures that the polarity of the battery pack 20 specified by the adapter unit 5 is correctly transferred to the supply terminals of the electric motor.

The intermediate element 11 can be positioned between the adapter unit 5 and the drive housing in a first position and a second position rotated by 180°. Upon a change from the first to the second position, the assignment of the contact pins 7 to the contact surfaces 12 is changed, which enables flexible adaptation of the electrical connection. However, this is only possible if an adapter unit 5 is simultaneously used, which has the first raised element 9 on the opposite side, since, if the intermediate element 11 is rotated, its second raised elements 15 would collide with the first raised elements 9 of the present adapter unit 5 and assembly would then not be possible. This is also desirable, since the battery pack 20 intended for use with the present adapter unit 5 has the polarity shown and not a reverse polarity.

The adapter unit 5 and the intermediate element 11 are therefore designed to ensure a safe and reliable electrical connection between a battery pack and an electric motor, while at the same time enabling easy assembly and disassembly. The use of compression springs 8 for mounting the contact pins 7 ensures a uniform contact force and thus a stable electrical connection.

FIG. 5 shows a drive unit in a view according to FIG. 5 with a battery pack, wherein from one view to the next, the intermediate element 11, the adapter unit 5 and the battery pack 20 are shown in different positions, wherein, in contrast to the preceding figures, the intermediate element 11 is mounted so as to be freely rotatable in its receptacle 22.

The movement sequence begins on the left side. The adapter unit 5 is placed on the intermediate element 11 and then turned to the left. The view is chosen in such a way that the distances between the components are maintained, which is solely intended to improve clarity. Naturally, the components, especially the respective raised elements 9 and 15, are intended to engage with each other.

After the adapter unit 5 is placed on the intermediate element 11, the rotation begins, wherein the first raised elements 9, with their flanks, quickly come into contact with the flanks of the second raised elements 15 of the intermediate element 11 and thus entrain the intermediate element 11 in the rotation. When the adapter unit 5 arrives in the position shown on the far right, only a screw fastening is provided, which fixes the adapter unit 5 to the drive housing 2 of the drive unit 1. The co-rotation of the intermediate element 11 ensures that the transmission of the voltage from the contact elements 6 of the adapter unit 5 always corresponds to the polarity of the electric motor.

The above description thus describes a drive unit which has an electric motor and which can be operated using battery packs from different manufacturers by simply replacing an adapter unit.

### LIST OF REFERENCE SIGNS

1 Drive unit
2 Drive housing
3 Connection portion
4 Screw receptacle
5 Adapter unit
6 Contact element
7 Contact pin
8 Compression spring
9 First raised element
10 Screw passage
11 Intermediate element
12 Contact surface
13 Plug-in element
14 Passage
15 Second raised element
17 Screw passage
18 First position
19 Second position
20 Battery pack
21 Mating contact element
22 Receptacle

1: A drive unit having a drive housing (2) in which an electric motor, in particular for operating a container pump, is accommodated, wherein the drive housing (2) is associated with an adapter unit (5) for the detachable accommodation of a battery pack (20), the adapter unit (5) having electrically conductive contact elements (6) for contacting mating contact elements (21) of the battery pack (20), and the contact elements (6) being electrically connected to supply terminals of an electric motor accommodated in the drive housing (2),
wherein the adapter unit (5) is detachably connected to the drive housing (2) with the interposition of an intermediate element (11) and has contact pins (7) electrically connected to the contact elements (6) for contacting contact surfaces (12) of the intermediate element (11) that are insulated from each other and connected, via wire leads, to the supply terminals of the electric motor, wherein the intermediate element (11) can be received between the adapter unit (5) and the drive housing (2) in a first position (18) and in a second position (19) rotated by 180° such that, a specific contact pin (7) in the first position (18) contacts a first of the contact surfaces (12), while the same contact pin (7) in the second position (19) contacts a second contact surface (12) different from the first contact surface (12), thereby reversing the polarity of the voltage transmitted to the electric motor.

2: The drive unit according to claim 1, wherein the contact surfaces (12) of the intermediate element (11) are formed as sheet metal inserts which are placed on the intermediate element (11) and form terminal, angled plug-in elements (13) which are guided through openings (14) of the intermediate element (11) and are connected to the wire leads beyond the openings (14).

3: The drive unit according to claim 2, wherein the contact surfaces (12) are received in recesses of the intermediate element (11), such that surfaces of contact surfaces (12) and intermediate element (11) merge flush with one another.

4: The drive unit according to claim 1, wherein the adapter unit (5) or the intermediate element (11) has raised elements and the counterpart has recesses, wherein contacting between the contact pins (7) and contact surfaces (12) only takes place in a position in which the raised elements engage in the recesses, and the raised elements and the recesses are positioned such that a polarity of the battery pack (20) specified by the adapter unit (5) is correctly transmitted from the intermediate element (11) to the supply terminals of the electric motor.

5: The drive unit according to claim 1, wherein the adapter unit (5) has first raised elements (9) and the intermediate element (11) has second raised elements (15), wherein the first raised elements (9) interact with corresponding second raised elements (15), wherein contacting between contact pins (7) and contact surfaces (12) only takes place in a position in which the first raised elements (9) are arranged next to the second raised elements (15), and the first raised elements (9) and the second raised elements (15) are positioned such that a polarity of the battery pack (20) specified by the adapter unit (5) is correctly transmitted from the intermediate element (11) to the supply terminals of the electric motor.

6: The drive unit according to claim 1, wherein the drive housing (2) has a tubular connection portion (3) for connection to the adapter unit (5), the tubular connection portion (3) interacting with the adapter unit (5) via a screw thread.

7: The drive unit according to claim 1, wherein the drive housing (2) has a receptacle (22) for the intermediate element (11), the intermediate element (11) being non-rotatably mounted in the receptacle (22).

8: The drive unit according to claim 1, wherein the drive housing (2) has a circular receptacle (22) for the intermediate element (11) and the intermediate element (11) is mounted so as to be freely rotatable in the receptacle (22).

9: The drive unit according to claim 1, wherein the adapter unit (5) has first raised elements (9) and the intermediate element (11) has second raised elements (15), wherein the first raised elements (9) interact with the second raised elements (15) via lateral flanks.

10: The drive unit according to claim 1, wherein the drive housing (2) has screw receptacles (4) that correspond to screw passages (10, 17) of the intermediate element (11) and the adapter unit (5) in an operating position of the adapter unit (5).

11: The drive unit according to claim 1, wherein the contact pins (7) of the adapter unit (5) are resiliently mounted against the contact surfaces (12) of the intermediate element (11) by means of compression springs (8).
